(19) United States
(12) Patent Application Publication
(10) Pub. No.: US 2005/0010726 A1
(43) Pub. Date: Jan. 13, 2005

(54) Low overhead read buffer

(76) Inventors: Barinder Singh Rai, Surrey (CA); Phil Van Dyke, Surrey (CA)

Correspondence Address: EPSON RESEARCH AND DEVELOPMENT INC;INTELLECTUAL PROPERTY DEPT, 150 RIVER OAKS PARKWAY, SUITE 225, SAN JOSE, CA, 95134, US

(21) Appl. No.: 10/616,802

(22) Filed: Jul. 10, 2003

(51) Int. Cl. G06F 12/00

(52) U.S. Cl. 711/137; 711/213; 712/238

(57) ABSTRACT

A memory controller includes logic for requesting a read operation from memory and logic for generating an address for the read operation. The memory controller also includes logic for storing both, data associated with the address and data associated with a consecutive address in temporary storage. Logic for determining if a request for data associated with a next read operation is for the data associated with the consecutive address in the temporary storage is also provided. A method for optimizing memory bandwidth, a device and an integrated circuit are also provided.

### BACKGROUND OF THE INVENTION

1. Field of the Invention

This invention relates generally to computer systems and more particularly to a method and apparatus for optimizing the access time and the power consumption associated with memory reads.

2. Description of the Related Art

Memory reads are typically much slower than other types of accesses due to the nature of dynamic random access memory (DRAM). For example, it may take 7 clocks to perform the first read. Subsequently, consecutive reads only take 1 clock. Thereafter, all non consecutive reads take 7 clocks. When an 8 bit or 16 bit read operation is performed, 32 bits are read out of memory and the appropriate 8 or 16 bits are placed on the bus. The remaining 8 or 16 bits from the 32 bit read are discarded. Therefore, if the central processing unit (CPU) requests the next 16 bits, an additional fetch from memory will have to be executed. More importantly, most reads from memory are consecutive but not necessarily required right away. Thus, a single read (7 clocks) and then at a later time another single read (7 clocks) is performed from the next address. FIG. 1 is a simplified schematic diagram illustrating the data flow through a memory controller. CPU 102 issues a read or write command which is received by host interface (IF) 104. Host IF 104 is in communication with memory controller 106. Memory controller 106 determines the location of the data associated with the CPU request in random access memory (RAM) 108.

One technique to address the shortcomings of the slow read accesses is to provide a read cache that incorporates prediction logic. The prediction logic predicts an address in memory where a next read will be directed. The data associated with the predicted address is then stored in the read cache. However, the read cache requires complex prediction logic, which in turn consumes a large amount of chip real estate. Furthermore, the prediction logic is executed over multiple CPU cycles in the background, i.e. there is a large overhead accompanying the read cache due to the prediction logic. In the instance where a CPU cycle generates a request for data not in the prediction branch, then everything in the prediction branch is discarded as the prediction is no longer valid. Consequently, the time associated with obtaining the data in the prediction branch was wasted. Furthermore, software associated with the prediction logic must be optimized.

As a result, there is a need to solve the problems of the prior art to provide a memory system configured to enable increased memory bandwidth without the high overhead penalty associated with prediction logic.

### SUMMARY OF THE INVENTION

Broadly speaking, the present invention fills these needs by providing a low power higher performance solution for increasing memory bandwidth and reducing overhead associated with prediction logic schemes. It should be appreciated that the present invention can be implemented in numerous ways, including as a process, a system, or a device. Several inventive embodiments of the present invention are described below.

In one embodiment, a method for optimizing memory bandwidth is provided. The method initiates with requesting data associated with a first address. Then, the data associated with the first address and the data associated with a consecutive address are obtained from a memory region in a manner transparent to a microprocessor. Next, the data associated with the first address and the data associated with the consecutive address are stored in a temporary data storage area. Then, the data associated with a second address is requested. Next, whether the data associated with the second address is stored in the temporary data storage area is determined through a configuration of a signal requesting the data associated with the second address.

In another embodiment, a method for efficiently executing memory reads based on a read command issued from a central processing unit (CPU) is provided. The method initiates with requesting data associated with a first address in memory in response to receiving the read command. Then, the data associated with the first address is stored in a buffer. Next, data associated with a consecutive address relative to the first address is stored in the buffer. The storing of both the data associated with the first address and the data associated with the consecutive address occur prior to the CPU being capable of issuing a next command following the read command. Then, it is determined if a next read command corresponds to the data associated with the consecutive address. If the next read command corresponds to the data associated with the consecutive address, the method includes, obtaining the data from the buffer.

In yet another embodiment, a memory controller is provided. The memory controller includes logic for requesting a read operation from memory and logic for generating an address for the read operation. The memory controller also includes logic for storing both, data associated with the address and data associated with a consecutive address in temporary storage. Logic for determining whether a request for data associated with a next read operation is for the data associated with the consecutive address in the temporary storage is also provided.

In still yet another embodiment, an integrated circuit is provided. The integrated circuit includes circuitry for issuing a command and memory circuitry in communication with the circuitry for issuing the command. The memory circuitry includes random access memory (RAM) core circuitry. A memory controller configured to issue a first request for data associated with an address of the RAM is included with the memory circuitry. The memory controller is further configured to issue a second request for data associated with a consecutive address to the address. A buffer in communication with the memory controller is provided with the memory circuitry. The buffer is configured to store the data associated with the address and the consecutive address in response to the respective requests for data. The data associated with the address and the consecutive address is stored prior to a next command being issued. The memory controller further includes circuitry configured to determine whether the second request is for the data associated with the consecutive address.

In another embodiment, a device is provided. The device includes a central processing unit (CPU). A memory region in communication with the CPU over a bus is included. The memory region is configured to receive a read command from the CPU. The memory region includes a read buffer for temporarily storing data and a memory controller in communication with the read buffer. The memory controller is configured to issue requests for either fetching data in memory having an address associated with the read command or fetching data in memory associated with a consecutive address to the address, where the requests are issued in response to receiving a read command from the CPU. The requests cause the data associated with the consecutive address to be stored in the read buffer prior to the CPU issuing a next command after the read command.

Other aspects and advantages of the invention will become apparent from the following detailed description, taken in conjunction with the accompanying drawings, illustrating by way of example the principles of the invention.

### BRIEF DESCRIPTION OF THE DRAWINGS

The present invention will be readily understood by the following detailed description in conjunction with the accompanying drawings, and like reference numerals designate like structural elements.

FIG. 1 is a simplified schematic diagram illustrating the data flow through a memory controller.

FIG. 2 is a high level schematic diagram of a data flow configuration that includes a low overhead buffer in accordance with one embodiment of the invention.

FIG. 3 is a more detailed schematic diagram of the configuration of the memory controller, the buffer and the memory core in accordance with one embodiment of the invention.

FIGS. 4A-4C pictorially illustrate the savings of clock cycles realized through various embodiments of the invention.

FIG. 5 is a simplified schematic diagram of the configuration of a device incorporating the optimized memory bandwidth configuration described herein in accordance with one embodiment of the invention.

FIG. 6 is a flow chart diagram illustrating the method operations for optimizing memory bandwidth in accordance with one embodiment of the invention.

### DETAILED DESCRIPTION OF THE PREFERRED EMBODIMENTS

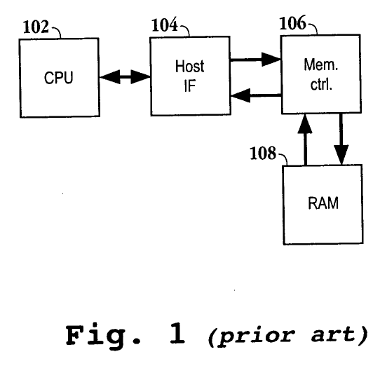

An invention is described for an apparatus and method for optimizing memory bandwidth and reducing the access time to obtain data from memory, which consequently reduces power consumption. It will be apparent, however, to one skilled in the art in light of the following disclosure, that the present invention may be practiced without some or all of these specific details. In other instances, well known process operations have not been described in detail in order not to unnecessarily obscure the present invention. FIG. 1 is described in the “Background of the Invention” section.

The embodiments of the present invention provide a self-contained memory system configured to reduce access times required for obtaining data from memory in response to a read command received by the memory system. A buffer, included in the memory system, is configured to store data that may be needed during subsequent read operations, which in turn reduces access times and power consumption. The memory system is configured to be self-contained, i.e., there is no background activity in which prediction logic determines where the next data is coming from, as is typical with a read cache. Thus, the embodiments described below require only a minimal amount of die area for the logic gates enabling the low overhead read buffer configuration.

In one embodiment, a memory controller of the memory system includes logic that fetches data associated with a requested address and data associated with consecutive sequential addresses to the requested address. The fetched data is then stored in a temporary storage region, such as a buffer. Once the row and column addresses are set up for a first read from memory, a read operation for data corresponding to a consecutive address, e.g., adjacent address to the first read address, occurs much quicker since there is no need to determine the storage location of the data. Furthermore, fetching the additional data is performed in a manner that is invisible to the central processing unit (CPU). That is, the fetches are completed prior to the CPU being able to issue another command following the read command that initiated the fetches. In other words, the fetches are completed within one CPU cycle. Accordingly, if the data associated with the additional fetches is not required by a next read command issued by the CPU, there has been no wasted time because of the self contained configuration of the memory system.

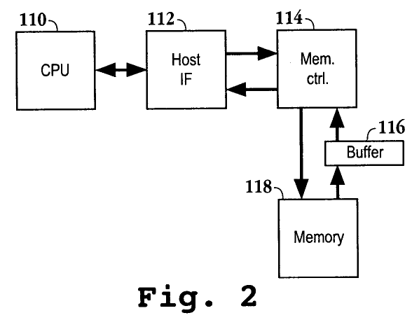

FIG. 2 is a high level schematic diagram of a data flow configuration that includes a low overhead buffer in accordance with one embodiment of the invention. Central processing unit (CPU) 110 is in communication with host interface (IF) 112. Memory controller 114 is shown in communication with host IF 112. Memory controller 114 is in communication with memory core, e.g., random access memory (RAM) 118. RAM 118 is in communication with buffer 116 which sits between RAM 118 and memory controller 114. Here, a read command issued by CPU 110 is received by host IF 112 and passed on to memory controller 114. Memory controller 114 sets up the read command, i.e., the row and column address and communicates the request to RAM 118. The data associated with the address is fetched from RAM 118 along with at least one other data set corresponding to a consecutive address location relative to the requested address location. The data associated with the requested address and the data associated with the consecutive address are stored in buffer 116. As will be explained in more detail below, memory controller 114 includes logic that determines if a next read command issued by CPU 110 is for data stored in buffer 116. It should be appreciated that CPU 110 may be a graphics controller.

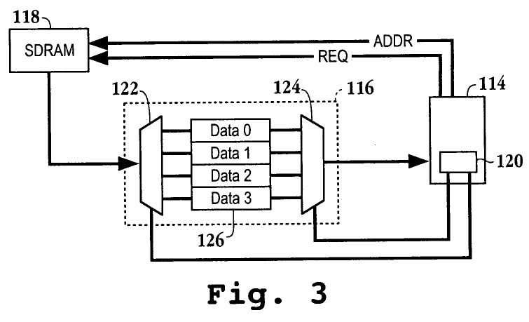

FIG. 3 is a more detailed schematic diagram of the configuration of the memory controller, the buffer and the memory core in accordance with one embodiment of the invention. Memory controller 114 communicates an address signal and a request signal to RAM 118. In one embodiment, RAM 118 may be a synchronous dynamic random access memory (SDRAM) One skilled in the art will appreciate that although this works with all memory types the biggest advantage is gained when cheap DRAM is used as SRAM may fetch data every clock. However, for a SRAM based system the benefits come from allowing other devices being allowed access to memory because the read cycle will be fetching from the buffer. That is, the scheme described herein allows parallelism in the design. It should be appreciated that one advantage which still remains is the situation where 32 bits are fetched but only 16 bits are needed. The next 16 bits are in the buffer so the memory does not need to be turned on, thereby saving power. It will be apparent to one skilled in the art that memory core 118 may be any suitable fast memory. In response to receiving the request and address signals, RAM 118 transmits the data associated with the particular address and requests signals to buffer 116. Buffer 116 includes demultiplexer 122, which distributes the data from RAM 118 into the appropriate storage location in storage region 126. Memory controller 114 includes selection and storage logic region 120. Selection and storage logic region 120 generates the select signals for the appropriate demultiplexers and multiplexer, 122 and 124 respectfully. Thus, memory controller 114, through selection and storage logic 120 may generate a read store select signal which is transmitted to multiplexer 122. It should be appreciated that the read store select signal is configured to cause the distribution of the data from RAM 118 to the appropriate storage location area in storage region 126 of buffer 116. Similarly, selection and storage logic region 120 may generate a data select signal which is communicated to multiplexer 124 of buffer 116 to access the appropriate data stored in storage region 126.

As will be explained in more detail below, when memory controller 114, of FIG. 3, receives a read request for data, memory controller 114 may be able to determine whether the data associated with the read request is contained within buffer 116. If the data is contained within buffer 116, memory controller 114, through selection and storage signal logic region 120, issues the appropriate data select signal for transmitting the appropriate data from storage region 126 to be placed on the bus. While buffer 116 is shown having storage area for four sets of data, it should be appreciated that buffer 116 may be of any suitable size. That is, buffer 116 may be able to store as many data sets that can be fetched within one CPU cycle. For example, where the CPU takes a particular number of clock cycles to turn around, then the read buffer can be made deeper, i.e., contain a greater amount of data. Thus, the slower the CPU, the larger the read buffer may be.

It should be appreciated that memory controller 114 supplies all of the control signals to the SDARM 118 of FIG. 3. In one embodiment, buffer 116 is a simple buffer. For example, assuming a 4 kilobyte SDRAM arranged as 4×1 kilobyte, i.e., 32 bits by 1024 rows, then 12 address lines are required to address all 4 kilobytes of SDRAM. Table 1 illustrates a comparison performed in the memory controller comparing the most significant bits of a previous address and a new address to determine if the data associated with the desired address is contained in the read buffer.

TABLE 1

| | |
|---|---|
| NEW ADDR[11:2]= =previous ADDR[11:2] | Data stored in read buffer. |
| | Each location determined |
| | by NEWADDR[1:0] |
| NEW ADDR[11:2]:=previous ADDR[11:2] | Data not stored in read |
| | buffer. Need to fetch new |
| | data from memory. |

Accordingly, if a previous address equals a new address then the desired read data is stored in read buffer 116. Therefore, the memory controller will transmit the SDRAM data select signal to multiplexer 124 in order to access the appropriate data in SDRAM 118. If the previous address is not equal to the new address, i.e., the upper bit or bits of the previous address and the new address are different, then read buffer 116 does not contain the desired data. Thus, the desired data is fetched from SDRAM 118. It will be apparent to one skilled in the art that the comparison may be performed through the use of a comparator in the memory controller.

In another embodiment, the 0 and 1 bits, i.e., least significant bits determine the number of fetches preformed. Table 2 illustrates the number of fetches performed for a four deep buffer on the values of bits 0 and 1.

TABLE 2

| ADDRESS [1:0] | FETCHES |
|---|---|
| 00 | 4 |
| 01 | 3 |
| 10 | 2 |
| 11 | 1 |

Thus, reading from address [1:0]=00 would require that 4 fetches are performed, i.e., a four deep buffer is filled up. Reading from address [1:0]=11 would require that 1 fetch from memory is exucted. It should be appreciated that while Table 2 illustrates a configuration of up to 4 fetches, more or less fetches may be performed depending on the size of the buffer and the number of address bits used for determining the amount of fetches. Thus the determination of whether the data is in the read buffer is made by the most significant bits while the location of the data in the buffer and the number of fetches to make when accessing data from memory are determined by the least significant bits of the new address.

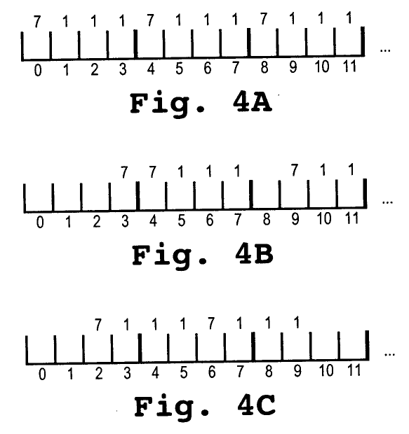

FIGS.4A-4C pictorially illustrate the savings and clock cycles realized through various embodiments of the invention. FIG. 4A illustrates a pictorial representation of a memory having addresses zero through eleven. Where initial address zero is requested, it may take seven memory clocks to retrieve the data for address zero from memory. It should be appreciated that the row address and column address must be set up initially, which results in the extended read cycles, e.g., 7 memory clock cycles. Subsequent reads from memory only take one memory clock cycle as the set up of the addresses is not necessary. That is, using the advantages of burst reads only one clock cycle is required for subsequent reads. Thus, to obtain the data associated with addresses 1, 2, and 3, only one clock cycle is required to obtain the data associated with each address. For example, four consecutive reads may take ten memory clock cycles (7+1+1+1) as opposed to 28 memory clock cycles (7+7+7+7) where a read buffer does not exist. As illustrated by FIG. 4A, the fetching of the data associated with read address 0 results in also fetching the data associated with read addresses 1, 2, and 3, i.e., the consecutive sequential addresses to read address 0. Here, three additional segments of data are fetched without the CPU aware of the additional fetches, i.e., in a transparent manner to the CPU. Accordingly, the additional fetches are completed prior to the CPU being able to perform another function, e.g., a read or write command. This scheme is repeated for read addresses 4-7, 8-11, etc. Of course, the use of a certain amount of clock cycles is for exemplary purposes as the specific configuration and components will determine the amount of clock cycles. However, the general scheme discussed herein is applicable to any suitable configuration associated with more or less clock cycles for setting up the addresses or fetching the data.

FIG. 4B illustrates an alternative embodiment to the fetching of the data from memory in response to receiving the read command. Here, the data associated with address 3 is initially requested which results in seven clock cycles to obtain the data. Then, the data from addresses four through seven is obtained with the data from address four taking seven clock cycles and the data associated with addresses five through seven each taking one clock cycle, similar to the scheme discussed with reference to FIG. 4A. Next, the data associated with addresses nine through eleven is requested where the data associated with address nine is fetched in seven clock cycles and the data associated with the consecutive addresses, ten and eleven, each take one memory clock cycle. It should be appreciated that if data associated with address eight is subsequently needed, then the data will have to fetched in 7 memory clock cycles as the data does not reside in the read buffer.

FIG. 4C illustrates yet another alternative to FIGS. 4A and 4B for fetching data from memory. Here, the data associated with address two and three through five is fetched in ten memory clock cycles. Then, the data associated with address six and seven through nine is also fetched in ten clock cycles. It should be appreciated that the logic required for performing the embodiment of FIG. 4C is more complex than the corresponding logic associated with the embodiments represented by FIGS. 4A and 4B. As a result, the more complex logic will occupy more chip real estate. Each of the addresses (0-11) in FIGS. 4A-4C represent 8 bits of data in one embodiment. Thus, for a 32 bit access, data from four addresses may be obtained. One skilled in the art will appreciate that if the access is for addresses 1-3 of the first four addresses, then addresses 1-3 are aligned for a 32 bit access.

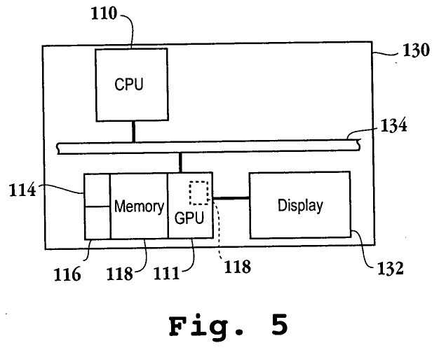

FIG. 5 is a simplified schematic diagram of the configuration of a device incorporating the optimized memory bandwidth configuration described herein in accordance with one embodiment of the invention. Device 130 includes CPU 110 and graphics controller 111. Memory 118, which is associated with memory controller 116 and buffer 114, is contained within graphics controller 111. Alternatively memory 118 may be connected to graphics controller 111. One skilled in the art will appreciate that system memory may be in communication with CPU 110 and graphics controller 111 over bus 134. Display screen 132 is in communication with graphics controller 111. It should be appreciated that device 130 may be any suitable handheld electronic device, such as, for example, a cellular phone, a personal digital assistant (PDA), a web tablet, etc. Additionally, device 130 may be a laptop computer or even a desktop computing system.

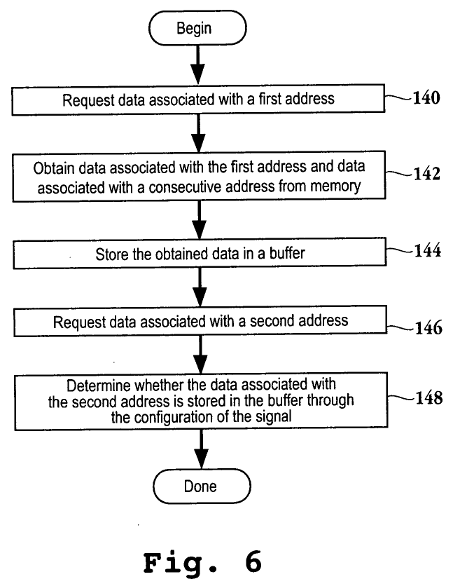

FIG. 6 is a flow chart diagram illustrating the method operations for optimizing memory bandwidth in accordance with one embodiment of the invention. The method initiates with operation 140 where the data associated with a first address is requested. Here, a CPU may issue a read command requesting data from memory. The method then advances to operation 142 where the data associated with the first address and data associated with a consecutive address are obtained from memory. Thus, as described above, the set up performed with the first address is taken advantage of and the data associated with one or more consecutive addresses is fetched also. As discussed with reference to FIGS. 3 and 4A-4C, the extra data is fetched within the CPU cycle. The method then proceeds to operation 144 where the data obtained from operation 142 is stored in a buffer. As described above with reference to FIG. 3, the buffer may store one or more sets of data associated with consecutive addresses from memory. It should be appreciated that the buffer may be any suitable temporary storage data region.

Still referring to FIG. 6, the method proceeds to operation 146 where data associated with the second address is requested. Here, the CPU issues a second read command for data in memory. The method then advances to operation 148 where it is determined whether the data associated with a second address is stored in the buffer through the configuration of the signal. In one embodiment, the most significant bits of the signal determine whether the data is in the buffer as discussed with reference to Table 2. If the data is in the buffer, then the memory controller will obtain the appropriate data from the buffer as described with reference to FIG. 3. If the data is not in the buffer, then the memory controller will fetch the data from memory along with the appropriate data from consecutive addresses and the cycle will be repeated as described above. The number of fetches to be performed depends on the configuration of the least significant bits as discussed with reference to Tables 1 and 2.

In summary, the embodiments described herein provide a low power higher performance solution for improved memory bandwidth. The advantages of burst reads are captured through the use of a buffer that holds data associated with consecutive addresses to an address associated with a read command. Since the address set up for the data associated with the read command consumes most of the memory clock cycles for the read cycle, the scheme exploits the fact that subsequent reads from memory when the addresses are set up only take one additional memory clock cycle. Thus, depending on how fast the CPU turns around, additional data from consecutive addresses may be fetched and stored in a read buffer. Therefore, subsequent memory reads for the consecutive data may access the data from the buffer thereby avoiding the address set up.

As described above, the memory fetches for the data associated with the consecutive addresses are completed prior to the CPU being capable of issuing another command. Thus, depending on the CPU cycle, the buffer may have various sizes. For example, if the CPU cycle takes 10 clocks and it takes 4 clocks to set up the address data, where each additional fetch after the set up data takes 1 clock, then the buffer can be sized as a 7×32 bit buffer. Therefore, the 4×32 bit buffer described above is for exemplary purposes only. Additionally, the simplicity of the scheme described above reduces the complexity of the logic required to enable the scheme. Consequently, the area needed for the logic is relatively small. Furthermore, the avoidance of prediction logic, which in turn eliminates the behind the scenes activity performed by the CPU, results in power savings.

With the above embodiments in mind, it should be understood that the invention may employ various computer-implemented operations involving data stored in computer systems. These operations are those requiring physical manipulation of physical quantities. Usually, though not necessarily, these quantities take the form of electrical or magnetic signals capable of being stored, transferred, combined, compared, and otherwise manipulated. Further, the manipulations performed are often referred to in terms, such as producing, identifying, determining, or comparing.

Any of the operations described herein that form part of the invention are useful machine operations. The invention also relates to a device or an apparatus for performing these operations. The apparatus may be specially constructed for the required purposes, or it may be a general purpose computer selectively activated or configured by a computer program stored in the computer. In particular, various general purpose machines may be used with computer programs written in accordance with the teachings herein, or it may be more convenient to construct a more specialized apparatus to perform the required operations.

The above described invention may be practiced with other computer system configurations including hand-held devices, microprocessor systems, microprocessor-based or programmable consumer electronics, minicomputers, mainframe computers and the like. Although the foregoing invention has been described in some detail for purposes of clarity of understanding, it will be apparent that certain changes and modifications may be practiced within the scope of the appended claims. Accordingly, the present embodiments are to be considered as illustrative and not restrictive, and the invention is not to be limited to the details given herein, but may be modified within the scope and equivalents of the appended claims.

1. A method for optimizing memory bandwidth, comprising:
requesting data associated with a first address;
obtaining the data associated with the first address and data associated with a consecutive address from a memory region in a manner transparent to a microprocessor;
storing the data associated with the first address and data associated with the consecutive address in a temporary data storage area;
requesting data associated with a second address; and
determining whether the data associated with the second address is stored in the temporary data storage area through a configuration of a signal requesting the data associated with the second address.

2. The method of claim 1, wherein the method operation of obtaining the data associated with the first address and data associated with a consecutive address from a memory region in a manner transparent to a microprocessor includes,
completing the obtaining the data associated with the first address and data associated with a consecutive address in one clock cycle associated with the microprocessor.

3. The method of claim 1, wherein the method operation of determining whether the data associated with the second address is stored in the buffer through a configuration of a signal requesting the data associated with the second address includes,
comparing the most significant bits of the signal to corresponding most significant bits of a previous signal; and
if the most significant bits of the signal are equal to the corresponding most significant bits of the previous signal, then the method includes,
accessing the data in the temporary data storage area.

4. The method of claim 1, wherein the method operation of determining whether the data associated with the second address is stored in the buffer through a configuration of a signal requesting the data associated with the second address includes,
comparing the most significant bits of the signal to corresponding most significant bits of a previous signal; and
if the most significant bits of the signal are not equal to the corresponding most significant bits of the previous signal, then the method includes,
fetching the data associated with the second address from the memory region; and
fetching consecutive data associated with the second address from the memory region.

5. The method of claim 4, further comprising:
determining an amount of consecutive data to fetch according to a value associated with the least significant bits of the signal.

6. A method for efficiently executing memory reads based on a read command issued from a central processing unit (CPU), comprising:
requesting data associated with a first address in memory in response to receiving the read command;
storing the data associated with the first address in a buffer;
storing data associated with a consecutive address relative to the first address in the buffer, the storing occurring prior to the CPU being capable of issuing a next command following the read command;
determining if a next read command corresponds to the data associated with the consecutive address; and
if the next read command corresponds to the data associated with the consecutive address, the method includes,
obtaining the data from the buffer.

7. The method of claim 6, further comprising:
if the next read command does not correspond to the data associated with the consecutive address, the method includes,
storing data associated with the next read command in the buffer; and
storing data having a consecutive address to the data associated with the next read command in the buffer.

8. The method of claim 6, wherein the method operation of determining if a next read command corresponds to the data associated with the consecutive address includes,
comparing a signal associated with the read command to a signal associated with the next read command.

9. The method of claim 6, wherein the method operation of storing data associated with a consecutive address relative to the first address in the buffer includes,
issuing a read store select signal; and
directing the data to a storage location of the buffer according to the read store select signal.

10. The method of claim 6, wherein the method operation of obtaining the data from the buffer includes,
determining a location of the data in the buffer through a data select signal.

11. A memory controller, comprising:
logic for requesting a read operation from memory;
logic for generating an address for the read operation;
logic for storing both, data associated with the address and data associated with a consecutive address in temporary storage; and
logic for determining if a request for data associated with a next read operation is for the data associated with the consecutive address in the temporary storage.

12. The memory controller of claim 11, wherein the logic for determining if a request for data associated with a next read operation is for the data associated with the consecutive address in the temporary storage includes,
a comparator configured to compare a signal corresponding to the request for data associated with a next read operation with a signal corresponding to the address for the read operation.

13. The memory controller of claim 11, wherein the logic for storing both, data associated with the address and data associated with a consecutive address in temporary storage is configured to issue a signal for distributing the data associated with the address and the data associated with the consecutive address in the temporary storage.

14. The memory controller of claim 11, wherein the logic for requesting a read operation from memory originates from a microprocessor.

15. The memory controller of claim 14, wherein the logic for storing both, data associated with the address and data associated with a consecutive address in temporary storage includes,
completing the storing prior to the microprocessor being capable of issuing any command following the read operation.

16. An integrated circuit, comprising:
circuitry for issuing a command;
memory circuitry in communication with the circuitry for issuing the command, the memory circuitry including,
a random access memory (RAM) core circuitry;
a memory controller configured to issue a first request for data associated with an address of the RAM, the memory controller further configured to issue a second request for data associated with a consecutive address to the address; and
a buffer in communication with the memory controller, the buffer configured to store the data associated with the address and the consecutive address in response to the respective requests for data, the data associated with the address and the consecutive address being stored prior to a next command being issued, wherein the memory controller includes circuitry configured to determine whether the second request is for the data associated with the consecutive address.

17. The integrated circuit of claim 16, wherein the memory circuitry further comprises:
a first multiplexer configured to distribute the data associated with the address and the data associated with the consecutive address into the buffer; and
a second multiplexer configured to select the data associated with the consecutive address when the second request is for the data associated with the second address.

18. The integrated circuit of claim 16, wherein the memory controller includes a comparator configured to compare a signal corresponding to the first request with a signal corresponding to the second request to determine if the data associated with the second request is in the buffer.

19. The integrated circuit of claim 16, wherein the RAM core circuitry is configured as synchronous dynamic random access memory (SDRAM) circuitry.

20. The integrated circuit of claim 16, wherein the memory controller includes selection and storage logic configured to enable one of distribution of the data associated with the address and the consecutive address into the buffer, and access to the data associated with the address and the consecutive address from the buffer.

21. A device, comprising:
a graphics processing unit (GPU);
a memory region in communication with the GPU over a bus,
the memory region configured to receive a read command from the GPU, the memory region including,
a read buffer for temporarily storing data; and
a memory controller in communication with the read buffer, the memory controller configured to issue requests for one of fetching data in memory having an address associated with the read command and fetching data in memory associated with a consecutive address to the address, in response to receiving a read command from the GPU, wherein the requests cause the data associated with the consecutive address to be stored in the read buffer prior to the GPU issuing a next command after the read command.

22. The device of claim 21, wherein the memory region includes,
a first multiplexer configured to distribute the data having the address and the data associated with the consecutive address into the buffer; and
a second multiplexer configured to select the data associated with the consecutive address when the next command is for the data associated with the second address.

23. The device of claim 21, wherein the memory controller further includes,
selection and storage logic configured to enable one of distribution of the data having the address and the data associated with the consecutive address into the buffer, and access to the data having the address and the data associated with the consecutive address from the buffer.

24. The device of claim 21, wherein the memory controller further includes, a comparator configured to compare a signal corresponding to the read command with a signal corresponding to a next read command to determine if data associated with the next read command is in the buffer.

25. The device of claim 21, wherein the device is a portable handheld electronic device.

26. The device of claim 21, further comprising:
a display screen configured to display image data.
